(19) United States
(12) Patent Application Publication
(10) Pub. No.: US 2016/0134428 A1
(43) Pub. Date: May 12, 2016

(54) User Device Evaluation for Online Meetings

(71) Applicant: Cisco Technology, Inc., San Jose, CA (US)

(72) Inventors: Hua Ouyang, Suzhou (CN); Qi Shi, Suzhou (CN); Huahua Yin, Suzhou (CN); Yunwei Luo, Suzhou (CN)

(21) Appl. No.: 14/537,986

(22) Filed: Nov. 11, 2014

(51) Int. Cl. H04L 12/18; H04L 29/08

(52) U.S. Cl. CPC H04L 12/1822; H04L 67/18

(57) ABSTRACT

Presented herein are techniques for detecting that a plurality of user devices are available for use by an individual to participate in an online meeting and evaluating the plurality of user devices to enable selection of an optimal user device for use during the online meeting. In one example, an online meeting server receives a request to initiate an evaluation of user devices for use by an individual/participant during an online meeting. The meeting server identifies a plurality of devices associated with the individual and sends a message to a first one of the plurality of user devices. The message enables display, to the individual, of an indication of two or more of the user devices for use during the online meeting.

### TECHNICAL FIELD

The present disclosure relates generally to online meetings.

### BACKGROUND

Online meetings or conference sessions enable individuals at remote or different locations to communicate with one another. In online meetings, the sharing of applications or desktop content is a common feature. The content is shared between a “presenter device” (i.e., the user device associated with the person/individual sharing the content) and one or more “attendee devices” (i.e., user devices associated with the other individuals attending the online meeting). When the presenter shares content, the shared content is captured at the presenter device and compressed as image data and sent to a meeting server. The meeting server then sends that compressed data to the attendee devices.

The presenter and attendee devices are user devices that may have a number of different forms. For example, the presenter and/or attendee devices may be computers (e.g., desktop computers, laptop computers, tablet computers, etc.), mobile devices (e.g., mobile phones), a display screen, teleconference system, etc.

### BRIEF DESCRIPTION OF THE DRAWINGS

FIGS. 1 and 2 are block diagrams illustrating a system configured to implement user device evaluation techniques in accordance with example embodiments presented herein.

FIGS. 3A-3F are tables illustrating scores for different device attributes in accordance with example embodiments presented herein.

FIG. 4 is a table illustrating example attribute values used in a suitability rating technique in accordance with example embodiments presented herein.

FIG. 5 is a schematic diagram of a device selection window in accordance with example embodiments presented herein.

FIG. 6 is a flow diagram illustrating details of the user device evaluation techniques in accordance with example embodiments presented herein.

FIGS. 7A-7C are schematic diagrams of device selection windows in accordance with example embodiments presented herein.

FIG. 8 is a block diagram of a meeting server in accordance with example embodiments presented herein.

FIG. 9 is a block diagram of a user device in accordance with example embodiments presented herein.

FIG. 10 is a high-level flowchart of a method in accordance with example embodiments presented herein.

### DESCRIPTION OF EXAMPLE EMBODIMENTS

### Overview

Presented herein are techniques for detecting that a plurality of user devices are available for use by an individual to participate in an online meeting and evaluating the plurality of user devices to enable selection of an optimal user device for use during the online meeting. In one example, an online meeting server receives a request to initiate an evaluation of user devices for use by an individual/participant during an online meeting. The meeting server identifies a plurality of devices associated with the individual and sends a message to a first one of the plurality of user devices. The message enables display, to the individual, of an indication of two or more of the user devices for use during the online meeting.

### Example Embodiments

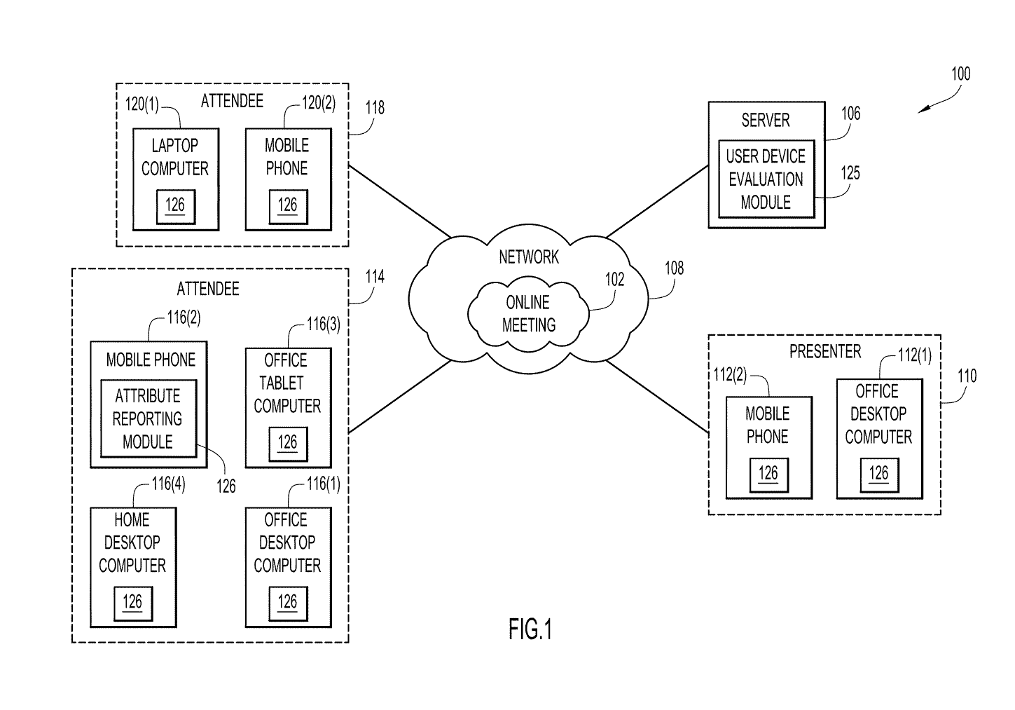

FIG. 1 is a block diagram of an example system 100 in which the user device evaluation techniques in accordance with examples presented herein may be implemented. The system 100 facilitates an online meeting/conference 102 between two or more user/participant devices, where the online meeting 102 may include the sharing of content. In general, content sharing within an online meeting may include “desktop sharing,” in which a device shares all of the desktop content (e.g., open documents, video content, images and/or any other content that is currently displayed by the user device) in real-time during the session, or “application sharing” in which only content associated with one or more specific applications is shared in real-time during the session.

The user device that shares the content with other user devices during online meeting 102 (i.e., where the shared content originates) is sometimes referred to as the “presenter” device and the associated user is referred to as the “presenter.” The user devices that receive the shared content (i.e., where the shared content is reproduced) are sometimes referred to as “attendee” devices and the associated users are referred to as “attendees.” The presenter and attendees are collectively referred to herein as “meeting participants” or “participants” and the user devices used to connect to the online meeting 102 are sometimes referred to herein as participant devices. Participant devices may take on a variety of forms, such as desktop computers, laptop computers, tablet computers, smartphones, and other device that has network connectivity, a display and a user interface.

In general, participants and participant devices described herein refer to individuals or user devices that are affiliated with an online meeting in some manner. In other words, participants and participant devices are not limited to individuals/devices that are connected to and actively taking part in an online meeting. Rather, participants and participant devices may also refer to individuals that have been invited to an online meeting (and have not yet joined the meeting) and devices that are associated with such individuals that have been invited to an online meeting.

Online meeting 102 is formed as a persistent network-based communication session using one or more suitable mechanisms (e.g., instant messaging, video conferencing, web or other on-line conferencing/meeting protocols, remote log-in and control of one computing device by another computing device, etc.) in which audio, video, document, screen image and/or any other type of content is shared between two or more user devices. The online meeting 102 may be hosted at a meeting server 106 that connects to the user devices and shares the content between the user devices using the network 108. The network 108 may be, for example, a local area network (LAN), wide area network (WAN), wireless WAN, wireless LAN etc., and any combination thereof.

In the example of FIG. 1, the online meeting 102 is joined by a presenter 110, a first attendee 114, and a second attendee 118. The presenter 110 and the attendees 114/118 are represented in FIG. 1 using dashed boxes. It should be understand that the presenter 110 and the attendees 114/118 would generally be an individual/person and are merely represented in FIG. 1 using dashed boxes for ease of description.

It is becoming increasingly common for individuals to have access to, or be associated with, a number of user devices at any given time. For example, in FIG. 1 the presenter 110 is associated with two user devices 112(1) and 112(2). User device 112(1) is a desktop computer located at the office of the presenter 110 (i.e., office desktop computer) and the user device 112(2) is a mobile phone located at the office of the presenter. Similarly, the attendee 114 is associated with four user devices 116(1)-116(4). User device 116(1) is a desktop computer located at the office of attendee 114 (i.e., office desktop computer), user device 116(2) is a mobile phone located at the office of the attendee, user device 116(3) is a tablet computer located at the office of the attendee (i.e., office tablet computer), and user device 116(4) is desktop computer located at the home of attendee 114 (i.e., home desktop computer). Attendee 118 is associated with two user devices 120(1) and 120(2). User device 120(1) is a laptop computer and the user device 112(2) is a mobile phone.

It is to be appreciated that FIG. 1 is an illustrative example of user devices that could be associated with the meeting participants at a given point in time and that the devices associated with each of the meeting participants may change. For ease of description, the user devices shown in FIG. 1 are assumed to be enabled with the functionality (e.g., software applications, hardware components, etc.) needed to join and participate in an online meeting.

Individuals may have different preferences of which devices to use when joining an online meeting. For example, certain individuals may prefer to join an online meeting via a desktop computer, while others may prefer to join an online meeting via a mobile device when out of the office or home. In preparation for an online meeting, the potential meeting participants generally receive a meeting invitation (e.g., an initial invitation, a reminder invitation, a message that includes a link to an online meeting, etc.). For example, in one specific arrangement attendee 114 receives an invitation for online meeting 102 via a mobile instant message (IM) at mobile phone 116(2). However, the attendee 114 may be in the office and prefer to join the online meeting 102 via the office desktop computer 116(1). Conventional arrangements do not provide a user-friendly mechanism to transfer the meeting invitation from the mobile phone 116(2) to the office desktop computer 116(1). Instead, the attendee 114 may copy/paste the details of the invitation into an email that may then be sent to, and opened at, the desktop computer 116(1). This is an inefficient solution that detracts from the user experience, but one which is increasingly common due to the widespread use of mobile devices such as phones, tablet computers, etc.

Accordingly, presented herein are user device evaluation techniques that enhance a user experience by enabling an individual to join or participate in an online meeting from any of a plurality of user devices associated with the individual, referred to herein as “associated devices.” Additionally, the user device evaluation techniques may analyze attributes of the associated devices and provide the individual with a recommendation of which user device(s) is/are suited for use during the online meeting. The user device evaluation techniques may be performed prior to joining an online meeting (i.e., for selecting a device to join the meeting) or during an online meeting (i.e., for selecting a different device to which an in-progress meeting may be transferred).

To enable the user device evaluation techniques, the meeting server 108 includes a user device evaluation module (evaluation module) 125 and the user devices associated with each of the meeting participants include an attribute reporting module 126. For ease of description, the user device evaluation techniques are primarily described herein with reference to mobile phone 116(2) that receives an invitation for online meeting 102 via a mobile IM. As noted elsewhere herein, an invitation to an online meeting may refer to any message or communication that relates to an online meeting. For example, the invitation may be the initial (first) message received by an individual about an online meeting, a subsequent reminder to join the meeting, a message with a link to the meeting, etc.

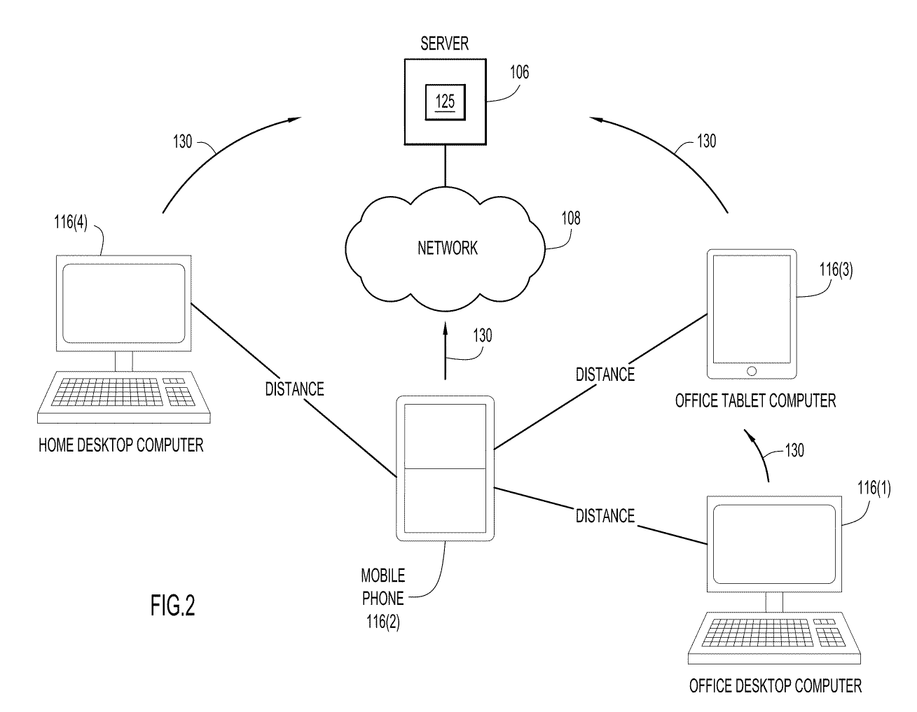

FIG. 2 is a block diagram illustrating operation of the user device evaluation techniques with reference to computing devices 116(1)-116(4) associated with attendee 114. For ease of illustration, the user devices associated with the other meeting participants 110 and 118 have been omitted from FIG. 2

As noted, the user devices 116(1)-116(4) associated with attendee 114 connect to meeting server 106 via network 108. Each of the user devices 116(1)-116(4) may be authenticated using, for example, account-login procedures, proximity-based authentication, etc. As shown by arrows 130, the user devices 116(1)-116(4) each report their associated device attributes to the meeting server 106. The device attributes associated with an user device generally include the geo-location information for the user device and the capability information for the user device. The geo-location information represents the physical location of the user device at a given time and may be provided to the sever 106 continually, periodically, or in response to the occurrence of an “update event.” An update event may occur, for example, when an user device detects that its location has changed by some specific amount (e.g., mobile phone is carried out of the attendee's office), when the user device is turned on, when an online meeting invitation is received, etc. The geo-location information may be used to calculate the distance between the user device that triggers the device evaluation and each of the other user devices associated with the attendee 114. In the specific example of FIG. 2, the geo-location information is used to calculate the distance between mobile phone 116(2) and each of the other user devices 116(1), 116(3), and 116(4).

Certain mobile devices can obtain their geo-location information via device instruments (e.g., associated global positioning system (GPS), etc.). For fixed user devices, such as the office desktop computer 116(1) and home desktop computer 116(4), the meeting server 106 can use the Internet Protocol (IP) address of a gateway associated with each of the desktop computers to calculate the geo-location information according to a public IP address.

The capability information that is reported to meeting server 106 represents the current computing capabilities, including the user device's network connection information such as the strength of the connection, the connection speed, the type of connection (e.g., LAN, 3G, Wi-Fi) etc., power information, device feature information, display information (e.g., display resolution), etc. The device feature information relates to the auxiliary features that are provided by the device, such as a camera, speaker, etc.

In certain examples, the meeting server 106, more particularly evaluation module 125, uses the information received from the user devices 116(1)-116(4) to score/rate the suitability of each of the user devices 116(1)-116(4) for use during the online meeting 102. As described in further detail below, the rating of the user devices 116(1)-116(4) may be based on the geo-location information and/or the capability information received from the computing devices 116(1)-116(4). Table 1, below, illustrates one example of the priority of the device attributes (i.e., how pieces of information are weighted for use in scoring the suitability of the user devices).

TABLE 1

| Priority of | |
|---|---|
| Information | Information Parameter |
| 1 | Distance (e.g., between a user device |
| | 116(1), 116(3), or 116(4) and the user |
| | device 116(2) at which a device evaluation is triggered) |
| 2 | Power |
| 3 | Network Speed |
| 4 | Network Bandwidth |
| 5 | Display Resolution |
| 6 | Camera |

In certain examples, suitability rating techniques may be implemented to assign suitability/recommendation score/rating for each of the user devices 116(1)-116(4). Equation 1, below, illustrates one example suitability/recommendation scoring equation that be employed in the suitability rating techniques.

Suitability Rating (for subject computing device)=Distance*Wd+Power*Wp+NetworkSpeed*Ws+NetworkBandwidth*Wb+Screen*Wr+Camera*Wc, where: Equation 1:

Distance is a value representing the distance between the subject device and the device at which a device evaluation is triggered;

Power is a value representing the power capabilities of the subject device;

NetworkSpeed is a value representing the speed of the network connection of the subject device;

NetworkBandwidth is a value representing the network bandwidth of the network connection of the subject device;

Screen is a value representing the size of the display screen of the subject device;

Camera is a value representing the camera capabilities of the subject device;

Wd is a weighting assigned to the distance information;

Wp is a weighting assigned to the power information;

Ws is a weighting assigned to the network connection speed;

Wb is a weighting assigned to the network bandwidth;

Wr is a weighting assigned to the display size information; and

Wc is a weighting assigned to the camera capabilities of a computing device.

In one example, the weights (Wd, Ws, Wb, Wr, and Wc) can be treated as a total sum equal to 100% (i.e., the sum Wd, Ws, Wb, Wr, and Wc=100%). In certain examples, the suitability rating techniques support dynamic weighting. For example, during a first device evaluation, Wd is 20%, but during a second evaluation Wd is 30%. As such, the score for a user device may be different in subsequent evaluations.

As noted above, the device attributes (e.g., geo-location and/or capability information) may be reported to the meeting server 106 by the computing devices 116(1)-116(4) and/or determined based on information received from the user devices 116(1)-116(4). In other words, some of the information used in the scoring/rating process may be received while some information may be calculated/determined.

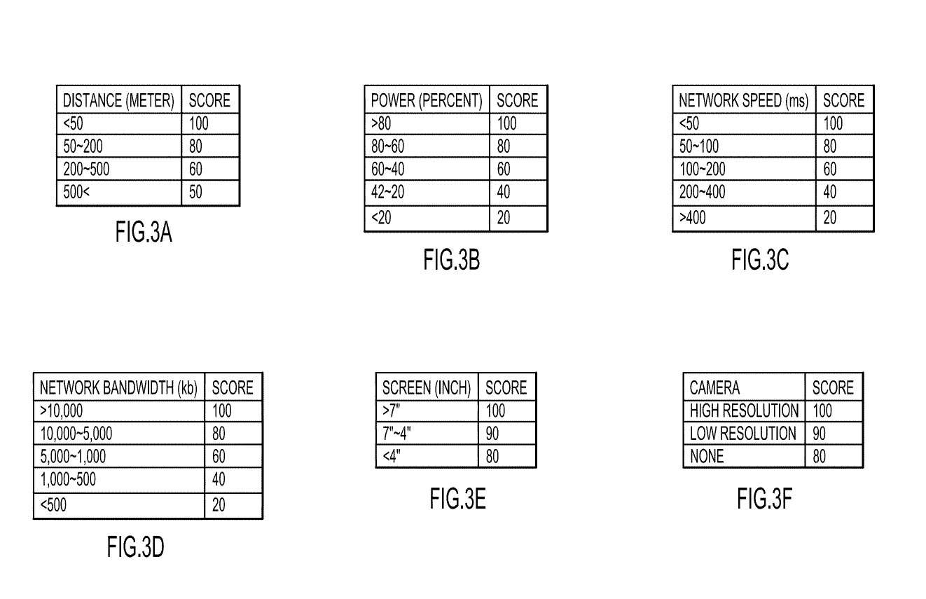

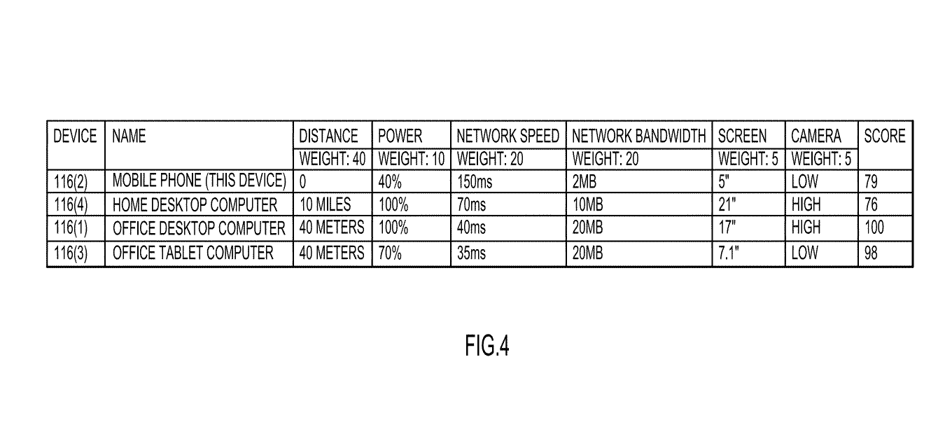

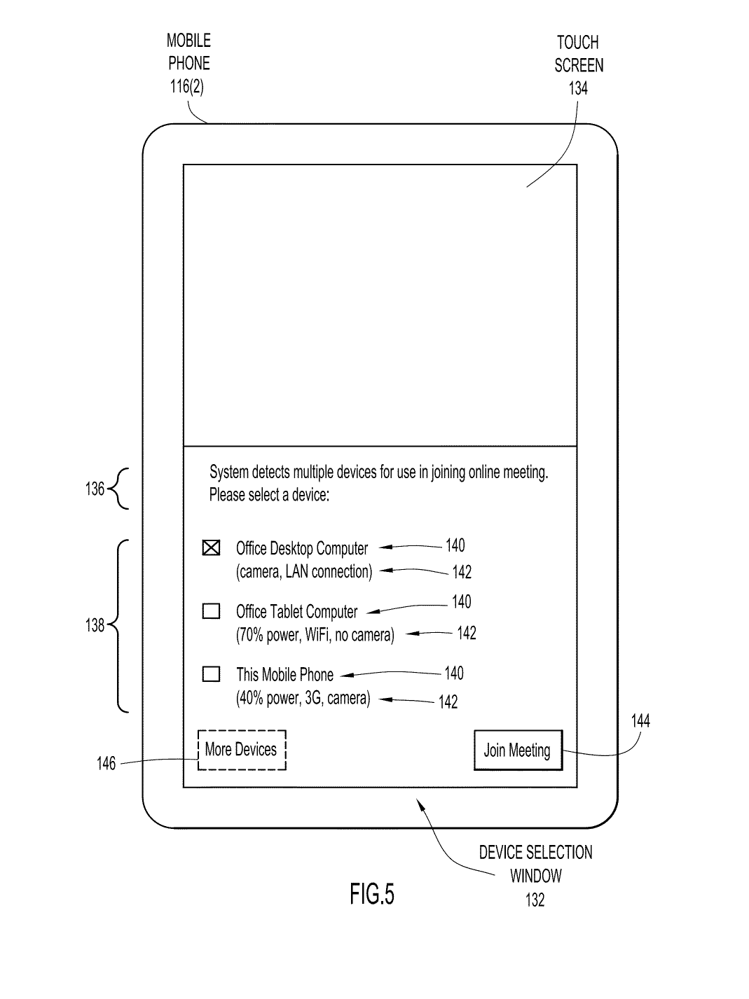

It would be appreciated that the geo-location and pieces of capability information may be in different formats. In accordance with examples presented herein, the evaluation module 125 normalizes the pieces of information into a selected format so that the different information may be used in a suitability scoring equation (e.g., Equation 1) to determine the device rankings. In one example, each piece of information is assigned a “score” between zero (0) and one hundred (100) and this score is used within the suitability scoring equation. FIGS. 3A-3F include tables that illustrate example scoring of different pieces of information.

More specifically, FIG. 3A illustrates example scoring of distances between a subject user device and a user device at which a device evaluation is triggered. FIG. 3B illustrates example scoring of various power capabilities of the subject user devices, FIG. 3C illustrates example scoring of various speeds for the network connection of the subject computing devices, FIG. 3D illustrates example scoring of various network bandwidths for the network connection of the subject user devices, FIG. 3E illustrates example scoring of various screen sizes of the subject user devices, and FIG. 3F illustrates example scoring of the camera capabilities of the subject user devices.

FIG. 4 is a table illustrating example values for the device attributes, including geo-location and capability information, obtained at meeting server 106 as well as a suitability rating that may be generated for each of the computing devices based on the example information. In this example, using Equation 1 and the values shown in the Tables of FIGS. 4A-4F and FIG. 5, the suitability ratings for each user device are calculated as:

Mobile Phone 116(2) Suitability Rating=0.4*100+0.1*60+0.2*60+0.2*60+0.05*90+0.05*90=79

Home Desktop Computer 116(4) Suitability Rating=0.4*50+0.1*100+0.2*80+0.2*100+0.05*100+0.05*100=76

Office Desktop Computer 116(1) Suitability Rating=0.4*100+0.1*100+0.2*100+0.2*100+0.05*100+0.05*100=100

Office Tablet Computer 116(3) Suitability Rating=0.4*100+0.1*80+0.2*100+0.2*100+0.05*100+0.05*90=98

Therefore, in this example, the office desktop computer 116(1) has the highest suitability rating and thus may be the recommended device for use in joining the meeting. As noted, a device selection window may be generated that enables the attendee 114 to select one of the devices for use during the meeting. Also as noted, the order of the devices in the device selection window may correspond to their associated suitability rating (i.e., Office Desktop Computer 116(1) is listed first, Office Tablet Computer 116(3) is listed second, Mobile Phone 116(2) is listed third, and Home Desktop Computer 116(4) may be listed last).

The above suitability ratings are specific to Equation 1. It is to be appreciated that Equation 1 is illustrative and that suitability ratings may be calculated using equations that include more or less input parameters. That is, certain equations may omit one of the Distance, Power, NetworkSpeed, NetworkBandwidth, Screen, or Camera parameters, while other equations may use additional parameters (e.g., screen resolution, user interface type, network connection type, etc.).

In accordance with certain examples presented herein, the evaluation module 125 at server 106 utilizes a predetermined or selected threshold distance to determine which user devices associated with a meeting participant are a candidate for use in joining an online meeting. In other words, the evaluation module 125 may execute a distance filter to determine which user devices may be used by a meeting participant to join an online meeting. For example, when an online meeting invitation is received at mobile phone 116(2), the threshold distance may be 1,000 meters. As such, only associated devices that are within 1,000 meters of the mobile phone 116(2) are eligible for use in joining the online meeting. In the example of FIG. 4, the office desktop computer 116(2) and the office tablet computer 116(3) are within the threshold distance and, as such, are the only devices that are eligible for use in joining the online meeting 102 (i.e., home desktop computer 116(4) is outside of the threshold distance and is not eligible for use in joining the online meeting).

FIG. 5 is a schematic diagram illustrating a device selection/recommendation window 132 (e.g., “pop-up” window) that may be generated based on the suitability ratings described above. The device selection window 132 is shown displayed at a touch screen 134 of the mobile phone 116(2). The touch screen 134 comprises a touch panel and a display screen. The touch screen 134 allows the attendee 114 to intuitively connect a pressure point of the touch panel with a corresponding point on the display screen, thereby creating an active connection with the screen. As such, the device selection window 132 is an interactive display that enables the attendee 114 to select one of the user devices that may be used to join the online meeting.

In FIG. 5, an invitation to the online meeting is received at mobile phone 116(2) via mobile IM. When the attendee 114 opens the invitation, the device evaluation is triggered at meeting server 106. The meeting server 106 provides the mobile phone 116(2) with data to generate and display the device selection window 132 at touch screen 134. The device selection window 132 first includes an indication 136 that multiple devices associated with the attendee 114 are available for use in joining the online meeting. The device selection window 132 also includes a list 138 of the user devices available for joining the meeting. For each available user device, the device selection window 132 provides an identifier 140 of the user device and an indication 142 of the capabilities of the user device. As described further below, the capabilities 142 that are included within device selection window 132 may vary depending, for example, on the associated device, meeting type, user preferences, etc. The displayed capabilities 142 enable the attendee 114 to further determine which user device may be the optimal device for use in joining and participating in the online meeting.

In certain examples, the order of the user devices within list 138 corresponds to their associated suitability rating (i.e., associated suitability for use in joining/participating in the online meeting). As such, the first user device within list 138 may be the “recommended” user device and the first user device displayed within list 138 may be pre-selected as the default user device for use in joining the online meeting.

As shown in FIG. 5, the device selection window 132 also displays a soft “join meeting” icon/button 144 that enables the attendee 114 to join the online meeting. In operation, the attendee 114 selects one of the listed user devices and then activates (e.g., pushes, swipes, etc.) the join meeting icon 144 which will initiate the online meeting functionality at the selected user device.

As can be seen in FIG. 5, the selected user device (i.e., the device selected by the attendee 114 from the list 138) may be different from the user device that displays the message window 132. For example, the device selection window 132 is displayed at mobile phone 116(2), but the attendee 114 selects (as identified by the “X” in FIG. 5) office desktop computer 116(1) for use in joining the online meeting. As such, once the user selects the office desktop computer 116(1) and activates the join meeting icon 144, the online meeting functionality is initiated at the office desktop computer 116(1).

In operation, the mobile phone 116(2) may push the meeting information to the office desktop computer 116(1) and the meeting client/application in the office desktop computer 116(1) is automatically launched. In one example, the meeting information is pushed to the meeting server 106 along with an instruction to transfer the meeting information to the office desktop computer 116(1). In another example, the meeting server 106 detects the selection of the different device, identifies the selected device, and automatically pushes the meeting information to the selected device along with an instruction to start the meeting client. In both cases, once the office desktop computer 116(1) receives the meeting information, the office desktop computer 116(1) may automatically launch the meeting client to join the meeting.

As noted above, examples presented herein may utilize a distance filter that limits the number of user devices that may be used to join an online meeting. In certain examples, only the user devices that satisfy the distance filter (i.e., are within a predetermined distance of the mobile phone 116(2)) are displayed within list 138. In further examples, the device selection window 132 may include a soft “More Devices” button icon (shown in FIG. 5 by dashed lines) that causes all of the associated devices to be displayed, without regard to the distance filter.

FIG. 5 illustrates an example in which the device selection window 132 includes a list 132 and the device recommendation is provided by listing the most suitable device first within the list. This recommendation technique shown in FIG. 5 is merely illustrative and device recommendations may be provided in other formats. For example, in one alternative arrangement the device selection window may provide an express textual/graphical recommendation (e.g., “Your Office Desktop Computer is Recommended for use in Joining the Meeting”).

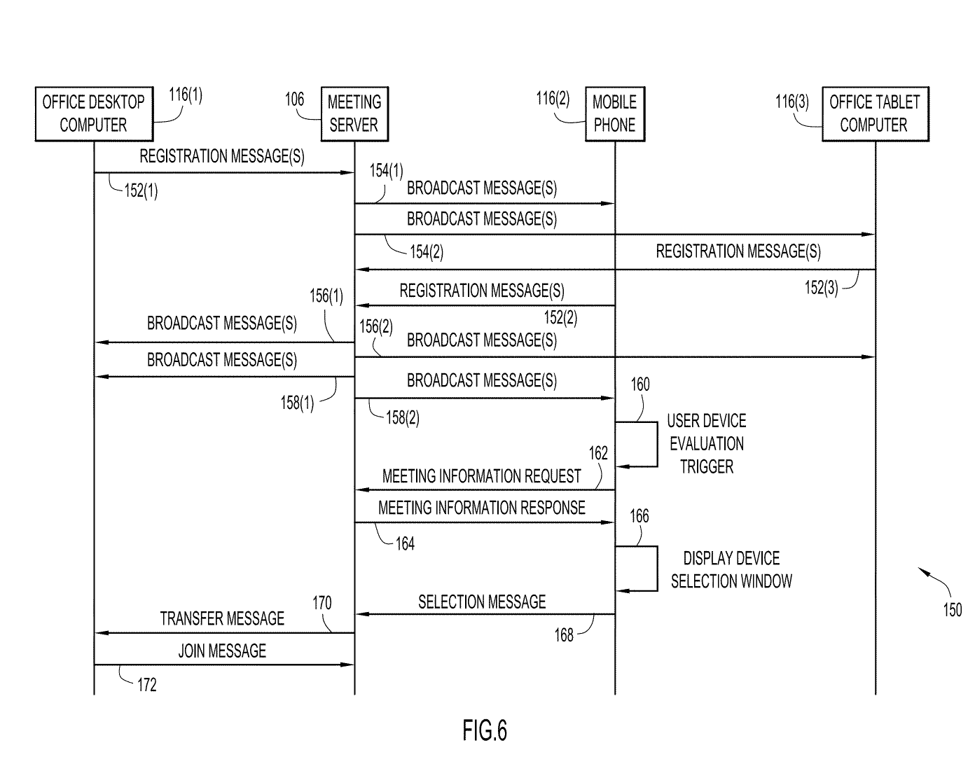

FIG. 6 is a flow diagram 150 illustrating further details of messages that may be sent between devices in accordance with examples presented herein. Flow diagram 150 is described with reference to user devices 116(1)-116(3) and meeting server 106 of FIG. 1. For ease of illustration, user device 116(4) has been omitted from the flow of FIG. 6.

As shown, office desktop computer 116(1) sends one or more reporting messages 152(1) to the meeting server 106. The reporting message(s) 152(1) may device attributes for the office desktop computer 116(1), including the geo-location information or information enabling the meeting server 106 to determine the geo-location information (e.g., an IP address that enables the meeting server to determine the location of the desktop computer) as well as the capability information (e.g., power, network speed, network width, display resolution, camera indication, etc.) for office desktop computer 116(1). The meeting server 106 then sends broadcast messages 154(1) and 154(2) to the mobile phone 116(2) and the office tablet computer 116(3), respectively. The broadcast messages 154(1) and 154(2) may include the geo-location and the capability information for office desktop computer 116(1).

The mobile phone 116(2) and the office tablet computer 116(3) also send similar reporting message(s) 152(2) and 152(3), respectively, to the meeting server 106. Broadcast messages 156(1) and 156(2) are sent to the office desktop computer 116(1) and the office tablet computer 116(3), respectively, to provide those devices with the geo-location and the capability information of mobile phone 116(2). Similarly, broadcast messages 158(1) and 158(2) are sent to the office desktop computer 116(1) and the mobile phone 116(2), respectively, to provide those devices with the geo-location and the capability information of tablet computer 116(3).

The reporting messages (and the subsequent broadcast messages) may be provided to the meeting sever 106 continually, periodically, or in response to the occurrence of an update event. An update event may occur, for example, when a user device detects that its location has changed by some specific amount (e.g., mobile phone is carried out of the attendee's office), when the user device is turned on, when an online meeting invitation is received, etc.

At 160, a user device evaluation is triggered either prior to or during an online meeting. The mobile phone 116(2) then sends a request 162 to meeting server 106 to obtain information related to the online meeting 102, such as the network bandwidth requirement (e.g., due to desktop sharing, multi-channel video, etc.), network delay (between mobile phone 116(2) and the meeting server 106), meeting duration, presenter's display/monitor size, etc. The request 162 may also operate as a notification that the meeting server 106 is to conduct the user device evaluation, as described elsewhere herein.

After performing the user device evaluation, the meeting server 106 issues a response 164 to mobile phone 116(2) and includes the information related to the online meeting 102 and the results of the user device evaluation. At 166, based on the information received from meeting server 106, a device selection window, such as device selection window 132 of FIG. 3, is displayed at mobile phone 116(2). In the example of FIG. 4, the attendee 114 selects desktop computer 116(1) and, in response, the mobile phone 116(2) sends a selection message 168 to the meeting server 106. The meeting server 106 then sends a transfer message 170 to the office desktop computer 116(2) which indicates that the online meeting 102 has been transferred to the office desktop computer 116(2). The office desktop computer 116(2) then automatically launches the online meeting client and sends a join message 172 to the meeting server 106 that enables the online meeting 102 to be launched at the office desktop computer 116(2).

FIG. 6 generally illustrates a “pre-meeting” example in which the user device evaluation is triggered prior to attendee 114 joining online meeting 102. In such examples, the user device evaluation and display of the device selection window may be triggered, for example, when the attendee 114 receives an invitation to online meeting 102 (online meeting invitation), clicks/opens an online meeting invitation or a link to online meeting 102, attempts to join online meeting 102 via a user device, etc. It is typical that an online meeting is initially scheduled and an invite is sent to potential meeting participants. At a later time, a reminder about the meeting may be sent to one or more participants. The reminder may include, for example, a link to the meeting, a web address for the meeting, etc. As noted elsewhere herein, reference to an online meeting invitation may also refer to an online meeting reminder or other communication regarding a meeting and not only to a first received invitation.

In certain circumstances, the user device evaluation occurs during an online meeting (e.g., the user device evaluation is triggered while the attendee 114 is connected to the online meeting 102). In accordance with such “in-meeting” examples, the user device evaluation may be triggered, for example, as a result of a detected change in meeting properties, including a change in network speed, a change (e.g., increase) in the delay between the user device and the meeting server, a change in the meeting bandwidth requirement, a change in the device attributes, etc. For example, in one specific in-meeting scenario, attendee 114 is connected to the online meeting 102 via the mobile phone 116(2) while the attendee enters his/her office. Upon entering the office, the meeting server 106 may be informed (e.g., by the mobile phone 116(2) or another device) that the attendee 114 is in proximity to other possible devices, including office desktop computer 116(1) and office tablet computer 116(3). In other words, office desktop computer 116(1) and office tablet computer 116(3) may be determined to satisfy a distance filter as described above (i.e., are within the selected threshold distance to mobile device 116(2)). In response, the meeting server 106 may initiate the display of a device selection window at the mobile phone 116(2) thereby providing the attendee 114 with the option and ability to directly transfer the online meeting 102 to the office desktop computer 116(1) or the office tablet computer 116(3). Similar to the above examples, the device selection window may provide a recommendation as which associated computing device the online meeting should be transferred.

In accordance with another in-meeting example, the attendee 114 is connected to the online meeting 102 through office desktop computer 116(1). A reduction in the speed of the LAN associated office desktop computer 116(1) is detected and meeting server 106 is notified of this reduction in network speed to trigger the user device evaluation. In response, the meeting server 106 may initiate the display of a device selection window at the desktop computer 116(1) thereby providing the attendee 114 with the option and ability to directly transfer the online meeting 102 to one or more other devices (e.g., to office tablet computer 116(3) that uses a Wi-Fi™ wireless LAN connection).

In accordance with another in-meeting example, network bandwidth often changes within the same device. For example, mobile phone 116(2) may have 2G, 3G and/or WiFi interfaces. The mobile phone 116(2) may use the different interfaces at different times (e.g., use Wi-Fi to connect Internet in certain circumstances, then use 3G, 4G or LTE to connect to the Internet in other circumstances). The available network bandwidth may impact the meeting performance and user experience. As such, a change in the network bandwidth and/or connection type may be detected and meeting server 106 is notified to trigger the user device evaluation. In response, the meeting server 106 may initiate the display of a device selection window at the desktop computer 116(1) thereby providing the attendee 114 with the option and ability to directly transfer the online meeting 102 to one or more other devices.

It is possible that online meetings may last for significant periods of time (e.g., an hour, multiple hours, an entire workday, etc.). Certain user devices, such as mobile phone 116(2) and office tablet computer 116(3), may have rechargeable power supplies that have a limited operational time period, particularly when running applications that cause the device to consume significant amounts of power. An online meaning that includes the sharing of desktops, audio, etc. may be an example of an application that causes a device to consume significant amounts of power. As such, certain examples set a minimum power threshold for a computing device that is used to participant in an online meeting. The user device, meeting server, etc. may monitor the power of the user device to trigger the user device evaluation. In response, the meeting server 106 may initiate the display of a device selection window at thereby providing the attendee 114 with the option and ability to directly transfer the online meeting 102 to one or more other devices. In other words, the user device evaluation may be triggered when the power level of the user device falls below the minimum power threshold.

In another example, the bandwidth requirements for an online meeting may change during a meeting. For example, the presenter may need share his/her desktop or an application with other participants, thereby increasing the bandwidth requirements for the online meeting. Additionally, there may different presenters in one meeting each requiring different bandwidths or an online meeting may include dynamic video data from different participants (e.g., sometimes only a few participants share his/her camera video, sometimes many participants share their video, etc.). The user device, meeting server, etc. may monitor the bandwidth requirements to trigger the user device evaluation. In response, the meeting server 106 may initiate the display of a device selection window at thereby providing the attendee 114 with the option and ability to directly transfer the online meeting 102 to one or more other devices. In other words, the user device evaluation may be triggered when the meeting bandwidth changes. In certain examples, the user device evaluation will be triggered when the meeting bandwidth changes by a predetermined amount and/or when the meeting bandwidth changes for a predetermined period of time.

In accordance with the above in-meeting examples, the device selection windows may provide a recommendation as which associated computing device the online meeting should be transferred. Additionally, the in-meeting examples may utilize “make-before-break” techniques to transfer the meeting between user devices. That is, the online meeting is started at the receiving user device before the online meeting is terminated at the transferring/sending computing device.

Described above are suitability rating techniques that assign a suitability score/rating to user devices associated with an individual and then using the suitability rating to generate a user device recommendation. Further examples presented herein may use attribute sorting techniques that select one or more attributes of the user devices to generate the user device recommendation. That is, in certain circumstances one or two attributes may be identified as key/controlling attributes and the recommendation may be generated based solely on these controlling attributes while ignoring/disregarding the other attributes. Equation 2, below, illustrates an example equation for recommending devices according to a selected attribute.

R=F(Devices,Attribute), where: Equation 2:

F is a sort function which can use a score table for an attribute (such as those shown in FIGS. 3A-3F) to sort the devices,

Devices are the devices associated with the attendee 114,

Attribute is the selected controlling attribute (e.g., power/distance/network speed/bandwidth/screen/camera), and

R is the result after the device.

In certain examples, Equation 2 may be expanded, as shown below in Equation 3, to include multiple nested sorting operations that may each generate different sub-groups.

R=Fn(F2(F1(Devices,Attribute 1),Attribute 2),Attribute N) Equation 3:

In other words, Equation 3 represents an example where the user devices 116(1)-116(4) may be sorted according to different attributes. Each sort is based on one of the attributes and may generate a different “sub-group” (i.e., a different order of the user devices). For example, Table 2, below shows an illustrative sort F1(Devices, distance) that is based on the geo-location information (i.e., distance between devices).

TABLE 2

| Distance (meters) | Result |
|---|---|
| Less than approximately 50 | Mobile Phone (this device) |
| | Office Desktop Computer |
| | Office Tablet Computer |
| Between approx. 50 and 200 | |
| Between approx. 200 and 500 | |
| Greater than approx. 500 | Home Desktop Computer |

The result of the sort F1(Devices, distance) is two sub-groups. The first sub-group (sub-group 1-1) includes, the mobile phone (this device) 116(2), the office desktop computer 116(1) and office tablet computer 116(3). The second sub-group (sub-group 1-2) includes home desktop computer 116(4).

Tables 3 and 4, below show a second illustrative sort F2(Devices, bandwidth) that uses the results shown above in Table 2 for separate sorts. In other words, Tables 3 and 4 illustrate sorts based on the bandwidth of the network connection associated with each of the devices, but correspond to sub-group 1-1 (Table 3) and sub-group 1-2 (Table 4).

TABLE 3

| Network Bandwidth (kBs) | Result |
|---|---|
| Greater than approx. 10,000 | Office Desktop Computer |
| | Office Tablet Computer |
| Between approx. 10,000 and 5,000 | |
| Between approx. 5,000 and 1,000 | Mobile Phone (this device) |
| Between approx. 1,000 and 500 | |
| Less than approx. 500 | |

TABLE 4

| Network Bandwidth (kBs) | Result |
|---|---|
| Greater than approx. 10,000 | Home Desktop Computer |
| Between approx. 10,000 and 5,000 | |
| Between approx. 5,000 and 1,000 | |
| Between approx. 1,000 and 500 | |
| Less than approx. 500 | |

The result of the sort F2(Devices, bandwidth) across the two sub-groups (sub-group 1-1 and sub-group 1-2) results in three additional sub-groups (sub-group 2-1, sub-group 2-2, and sub-group 2-3). The first sub-group (sub-group 2-1) includes, the office desktop computer 116(1) and the office tablet computer 116(3). The second sub-group (sub-group 2-2) includes mobile phone (this device) 116(1), and the third sub-group (sub-group 2-3) includes home desktop computer 116(4).

Tables 5, 6, and 7, below show a third illustrative sort F3(Devices, speed) that uses the results shown above in Tables 3 and 4 for separate sorts. In other words, Tables 5, 6, and 7, illustrate sorts based on the speed of the network connection associated with each of the devices, but correspond to sub-group 2-1 (Table 5), sub-group 2-2 (Table 6), and sub-group 2-3 (Table 7).

TABLE 5

| Network Speed (ms) | Result |
|---|---|
| Less than approximately 50 | Office Desktop Computer |
| | Office Tablet Computer |
| Between approx. 50 and 100 | |
| Between approx. 100 and 200 | |
| Between approx. 200 and 400 | |
| Greater than approx. 400 | |

TABLE 6

| Network Speed (ms) | Result |
|---|---|
| Less than approximately 50 | |
| Between approx. 50 and 100 | |
| Between approx. 100 and 200 | Mobile Phone (this device) |
| Between approx. 200 and 400 | |
| Greater than approx. 400 | |

TABLE 7

| Network Speed (ms) | Result |
|---|---|
| Less than approximately 50 | |
| Between approx. 50 and 100 | Home Desktop Computer |
| Between approx. 100 and 200 | |
| Between approx. 200 and 400 | |
| Greater than approx. 400 | |

The result of the sort F3(Devices, speed) across the three sub-groups (sub-group 2-1, sub-group 2-2, and sub-group 2-3) results in three additional sub-groups (sub-group 3-1, sub-group 3-2, and sub-group 3-3). The first sub-group (sub-group 3-1) includes, the office desktop computer 116(1) and the office tablet computer 116(3). The second sub-group (sub-group 3-2) includes mobile phone (this device) 116(1), and the third sub-group (sub-group 3-3) includes home desktop computer 116(4). Due to the above three sorts, the office tablet computer 116(3) is the recommended device.

The different sub-groups may be displayed to the attendee 114 in response to user inputs. The order of the user devices within each displayed sub-group may reflect their associated recommendation based on the corresponding attribute. Information regarding the actual value of the selected attribute(s) or other attributes may also be displayed with the sub-group.

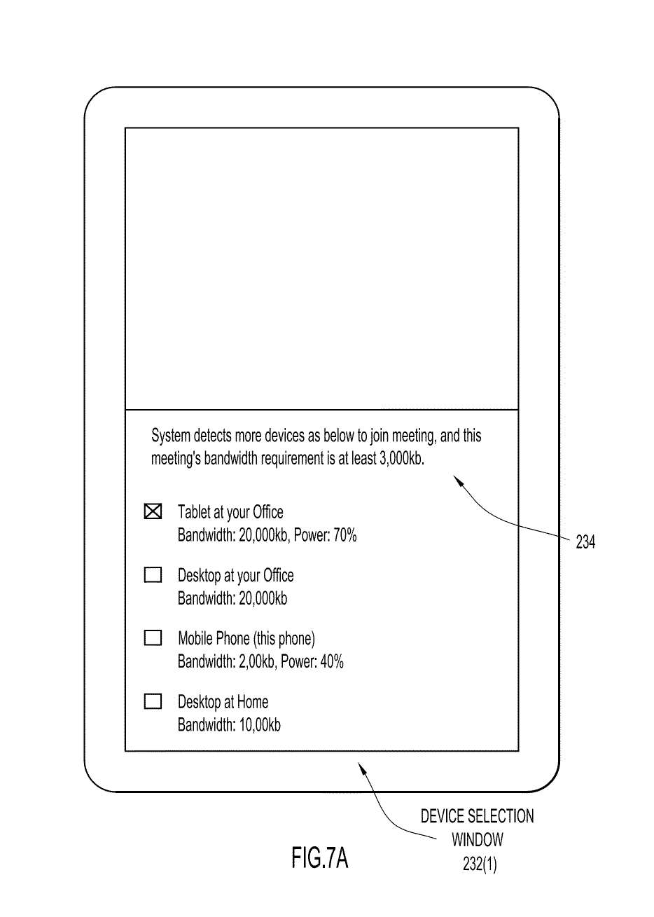

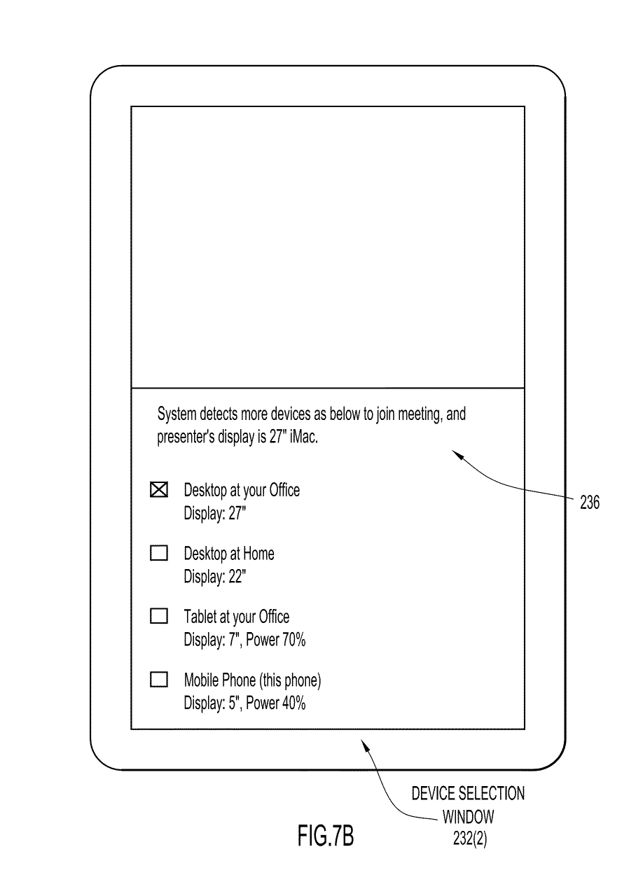

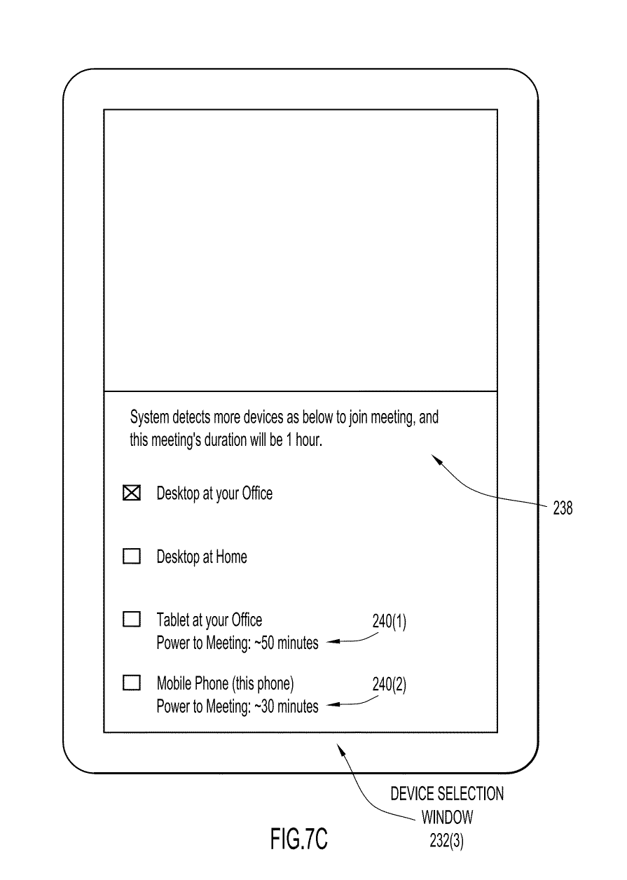

More specifically, FIGS. 7A-7C are schematic diagrams illustrating device selection windows that may be displayed in response to the attribute sorting techniques. More specifically, FIG. 7A illustrates a device selection window 232(1) generated based on a network bandwidth sort (i.e., sorting the devices according to their associated network bandwidth). The device selection window 232(1) also includes a message 234(1) that identifies the bandwidth requirements for the online meeting. The device selection window 232(1) also indicates the bandwidth available at each of the computing devices 116(1)-116(4) and the power capabilities of the user device (where the associated user device includes a rechargeable power supply).

FIG. 7B illustrates a device selection window 232(2) generated based on a display size sort (i.e., sorting the devices according to their associated display size). The device selection window 232(2) also includes a message 236 that identifies the screen size of the presenter's user device. The device selection window 232(2) also indicates the actual display size for each of the computing devices 116(1)-116(4) and the power capabilities of the user device (where the associated user device includes a rechargeable power supply).

FIG. 7C illustrates a device selection window 232(3) generated based on a power capability sort (i.e., sorting the devices according to their associated power capabilities). The device selection window 232(3) also includes a message 238 that identifies the estimated duration of the online meeting. For computing devices that operate using a rechargeable power supply, the device selection window 232(3) provides indications 240(1) and 240(2) of how long the power of the user devices will last during a meeting. As shown in the example of FIG. 7C, the power of the office tablet computer 116(3) is estimated to run out after approximately fifty (50) minutes, while the power of the mobile phone 116(2) is estimated to run out after approximately thirty (30) minutes.

In certain examples, the attribute sorting techniques may be used in combination with the suitability rating techniques. More specifically, a device selection window providing a recommendation to attendee 114 may be initially generated in accordance with either the attribute sorting techniques or the suitability rating techniques. Based on, for example, one or more user inputs, the device selection window may change the order of displayed devices (i.e., change the device recommendation). For example, a device selection window may be generated initially using the suitability rating techniques. However, attendee 114 may prefer to identify which device has the fastest network connection. As such, the attendee 114 may initiate a sort in which the computing devices 116)1)-116(4) are displayed in an order that reflects the speed of their associated network connection.

Additionally, the suitability rating techniques and the attribute sorting techniques may also include one or more filter mechanisms. For example, computing devices having attributes that do not satisfy certain requirements may be omitted from the selection/recommendation process (e.g., omit devices with a distance greater than 300 meters, omit devices with less than 30% power, etc.).

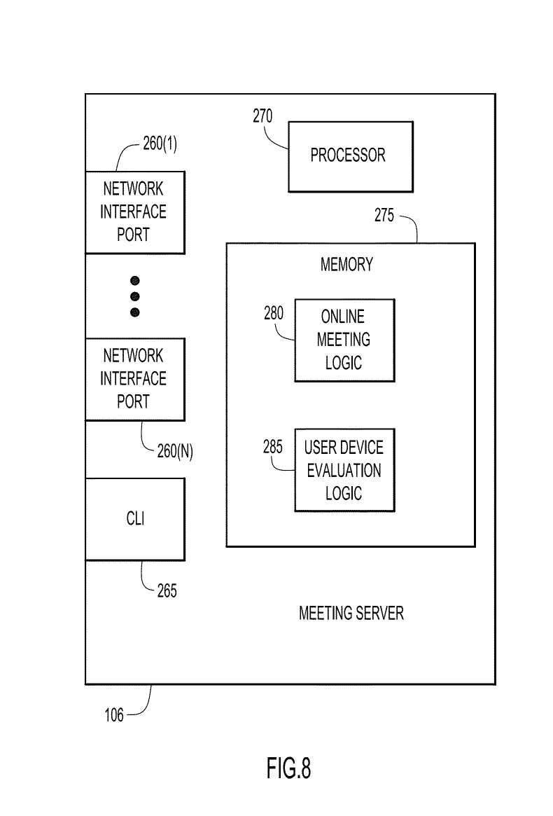

FIG. 8 is a block diagram of a meeting server, such as meeting server 106, configured to operate in accordance with examples presented herein. As shown, meeting server 106 comprises a plurality of network interface units (e.g., ports) 260(1)-260(N), a command-line interface (CLI) 265, a processor 270, and a memory 275 comprising online meeting logic 280 and user device evaluation logic 285.

The network interface units 260(1)-260(N) provide network communications between the meeting server and the user devices and other network components. Network interface units 260(1)-260(N) may be, for example, Ethernet ports of a network interface card (NIC) implemented in one or more application-specific integrated circuits (ASICs). The CLI 265 is a mechanism by which commands can be delivered to the meeting server 106 in the form of successive lines of text (command lines). It should be appreciated that use of the CLI 265 is merely an example and that other mechanisms may also or alternatively be provided for a network administrator to deliver commands to the meeting server 106.

Memory 275 may comprise read only memory (ROM), random access memory (RAM), magnetic disk storage media devices, optical storage media devices, flash memory devices, electrical, optical, or other physical/tangible memory storage devices. The processor 270 is, for example, a microprocessor or microcontroller that executes instructions for the online meeting logic 280 and the user device evaluation logic 285. Thus, in general, the memory 275 may comprise one or more tangible (non-transitory) computer readable storage media (e.g., a memory device) encoded with software comprising computer executable instructions and when the software is executed (by the processor 270) it is operable to perform the operations described herein in connection with setting up and hosting an online meeting (through execution of online meeting logic 280) and to perform the operations described herein with connection to the user device evaluation techniques (through execution of user device evaluation logic 285).

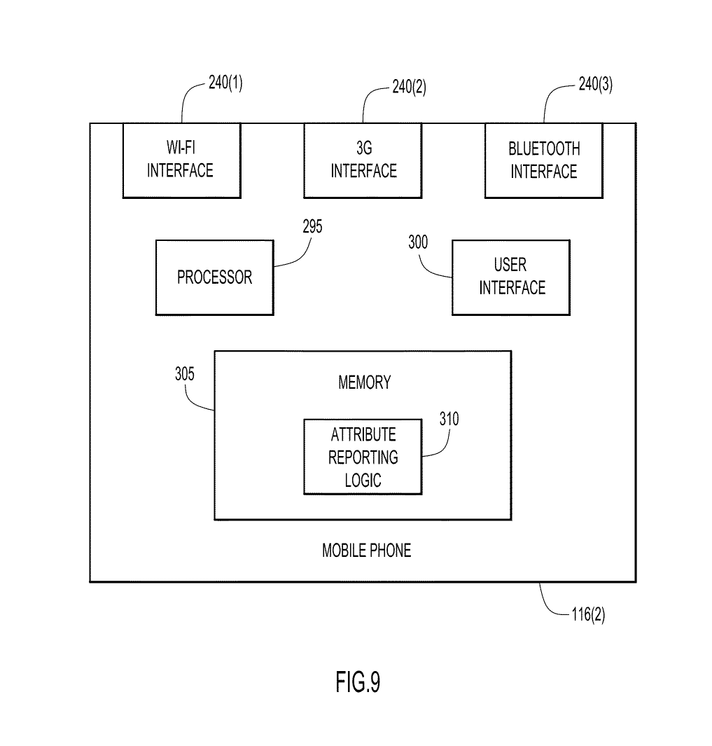

FIG. 9 is a block diagram illustrating further details of a user device, such as mobile phone 116(2), configured to operate in accordance with examples presented herein. As shown, mobile phone 116(2) comprises three different types of wireless interfaces, including Wi-Fi interface 290(1), 3G interface 290(2), and Bluetooth interface 290(3). Mobile phone 116(2) further comprises processor 295, user interface 300, and a memory 305. Memory 305 comprises attribute reporting logic 310. The user interface 300 may take many different forms and may include, for example, a keypad, keyboard, mouse, touchscreen, display screen, etc.

Memory 305 may comprise ROM, RAM, magnetic disk storage media devices, optical storage media devices, flash memory devices, electrical, optical, or other physical/tangible memory storage devices. The processor 295 is, for example, a microprocessor or microcontroller that executes instructions for the attribute reporting logic 310. Thus, in general, the memory 305 may comprise one or more tangible computer readable storage media (e.g., a memory device) encoded with software comprising computer executable instructions and when the software is executed (by the processor 295) it is operable to perform the operations described herein in connection with attribute reporting module 126 (FIG. 1). More specifically, attribute reporting logic 310, when executed by processor 295, provides the functionality for mobile phone 116(2) to report attributes to the meeting server 106.

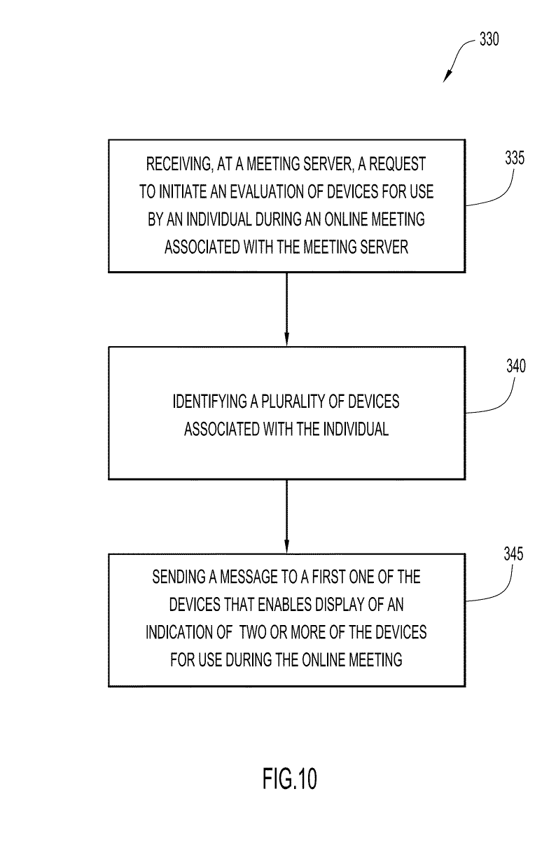

FIG. 10 is flowchart of a method 330 in accordance with aspects presented herein. Method 330 begins at 335 where an online meeting server receives a request to initiate an evaluation of user devices for use by an individual during an online meeting. At 340, a plurality of user devices associated with the individual is identified by the meeting server. At 345, the meeting server sends a message to a first one of the user devices that enables display, to the individual, of an indication of two or more of the user devices for use during the online meeting.

Presented herein are techniques for identifying a plurality of user devices that may be used to join an online meeting and, in certain examples, generating a real-time recommendation of a user device for use by a participant of an online meeting. The techniques presented herein may use real-time information and provide a meeting participant with the ability to select one of a plurality of user devices. The techniques may improve the user experience and enhance collaboration between user devices associated with a meeting participant.

To summarize, in one form, a computer-implemented method is provided comprising: receiving, at a meeting server, a request to initiate an evaluation of devices for use by an individual during an online meeting associated with the meeting server; identifying a plurality of devices associated with the individual; and sending a message to a first one of the devices that enables display of an indication of two or more of the devices for use during the online meeting.

In another form, an apparatus is provided comprising: one or more network interface units; a memory; and a processor coupled to the memory and network interface units, wherein the processor: receives a request to initiate an evaluation of devices for use by an individual during an online meeting associated; identifies a plurality of devices associated with the individual; and sends a message to a first one of the devices that enables display of an indication of two or more of the devices for use during the online meeting.

In still another form, one or more computer readable storage media are provided encoded with software comprising computer executable instructions and when the software is executed operable to: receive a request to initiate an evaluation of devices for use by an individual during an online meeting; identify a plurality of devices associated with the individual; and send a message to a first one of the devices that enables display of an indication of two or more of the devices for use during the online meeting.

Described above are examples. The concepts described herein may be embodied in other specific forms without departing from the spirit or essential characteristics thereof. The foregoing examples are therefore to be considered in all respects illustrative and not meant to be limiting. Accordingly, it is intended to embrace all such alterations, modifications and variations that fall within the spirit and scope of any claims filed in applications claiming priority hereto interpreted in accordance with the breadth to which they are fairly, legally and equitably entitled.

What is claimed is:

1. A computer-implemented method comprising:
receiving, at a meeting server, a request to initiate an evaluation of devices for use by an individual during an online meeting associated with the meeting server;
identifying a plurality of devices associated with the individual; and
sending a message to a first one of the devices that enables display of an indication of two or more of the devices for use during the online meeting.

2. The method of claim 1, wherein the request is received before the individual joins the online meeting from one of the plurality of devices.

3. The method of claim 1, wherein the request is received after the individual joins the online meeting from one of the plurality of devices.

4. The method of claim 1, further comprising:
evaluating one or more attributes of the devices to identify one of the plurality of devices as a recommended device for use during the online meeting,
wherein the message enables a display of information indicating the recommended device.

5. The method of claim 4, wherein evaluating one or more attributes of the devices to identify the recommended device for use during the online meeting comprises:
analyzing geo-location information associated with each of the devices.

6. The method of claim 5, further comprising:
calculating, based on the geo-location information, a distance between the first one of the devices and each of the other devices associated with the individual.

7. The method of claim 4, wherein the one or more attributes comprise:
geo-location information representing the present location of the associated device; and
capability information representing the current capabilities of the associated device.

8. The method of claim 4, wherein the message includes data enabling the display of information identifying the two or more devices, the recommended device being one of the two or more devices.

9. The method of claim 1, wherein the message includes data that enables the display of one or more attributes for each of the two or more devices.

10. An apparatus comprising:
one or more network interface units;
a memory; and
a processor coupled to the memory and network interface units, wherein the processor:
receives a request to initiate an evaluation of devices for use by an individual during an online meeting associated;
identifies a plurality of devices associated with the individual; and
sends a message to a first one of the devices that enables display of an indication of two or more of the devices for use during the online meeting.

11. The apparatus of claim 10, wherein the request is received before the individual joins the online meeting from one of the plurality of devices.

12. The apparatus of claim 10, wherein the request is received after the individual joins the online meeting from one of the plurality of devices.

13. The apparatus of claim 10, wherein the processor further:
evaluates one or more attributes of the devices to identify one of the plurality of devices as a recommended device for use during the online meeting,
wherein the message enables a display of information indicating the recommended device.

14. The apparatus of claim 13, wherein the processor analyzes geo-location information associated with each of the devices to identify the recommended device for use during the online meeting.

15. The apparatus of claim 14, wherein the processor:
calculates, based on the geo-location information, a distance between the first one of the devices and each of the other devices associated with the individual.

16. The apparatus of claim 13, wherein the one or more attributes comprise:
geo-location information representing the present location of the associated device; and
capability information representing the current capabilities of the associated device.

17. The apparatus of claim 13, wherein the message includes data enabling the display of information identifying the two or more devices, the recommended device being one of the two or more devices.

18. The apparatus of claim 10, wherein the message includes data that enables the display of one or more attributes for each of the two or more devices.

19. One or more computer readable storage media encoded with software comprising computer executable instructions and when the software is executed operable to:
receive a request to initiate an evaluation of devices for use by an individual during an online meeting;
identify a plurality of devices associated with the individual; and
send a message to a first one of the devices that enables display of an indication of two or more of the devices for use during the online meeting.

20. The computer readable storage media of claim 19, wherein the request is received before the individual joins the online meeting from one of the plurality of devices.

21. The computer readable storage media of claim 19, wherein the request received after the individual joins the online meeting from one of the plurality of devices.

22. The computer readable storage media of claim 19, further comprising instructions operable to:
evaluate one or more attributes of the devices to identify one of the plurality of devices as a recommended device for use during the online meeting,
wherein the message enables a display of information indicating the recommended device.

23. The computer readable storage media of claim 22, wherein the instructions operable to evaluate one or more attributes of the devices to identify the recommended device for use during the online meeting comprise instructions operable to:
analyze geo-location information associated with each of the devices.

24. The computer readable storage media of claim 23, further comprising instructions operable to:
calculate, based on the geo-location information, a distance between the first one of the devices and each of the other devices associated with the individual.

25. The computer readable storage media of claim 22, wherein the one or more attributes comprise:
geo-location information representing the present location of the associated device; and
capability information representing the current capabilities of the associated device.

26. The computer readable storage media of claim 22, wherein the message includes data enabling the display of information identifying the two or more devices, the recommended device being one of the two or more devices.

27. The computer readable storage media of claim 19, wherein the message includes data that enables the display of one or more attributes for each of the two or more devices.
